(19) United States
(12) Patent Application Publication
(10) Pub. No.: US 2015/0332234 A1
(43) Pub. Date: Nov. 19, 2015

(54) SYSTEM FOR CARD PAYMENT IN THE ELECTRONIC COMMERCE AND METHOD THEREOF

(71) Applicant: Chul Hoon Choi, Seoul (KR)

(72) Inventor: Chul Hoon Choi, Seoul (KR)

(21) Appl. No.: 14/710,207

(22) Filed: May 12, 2015

(30) Foreign Application Priority Data
May 13, 2014 (KR) 10-2014-0057234

(51) Int. Cl. G06Q 20/14; G06Q 20/34; G06Q 20/38

(52) U.S. Cl. CPC G06Q 20/14; G06Q 20/38; G06Q 20/34

(57) ABSTRACT

Provided is a card payment system and method in an electronic transaction, which can effectively solve authentication and security problems that are caused by Active-X programs that are indiscriminately installed, by performing a card payment in a complex hybrid authentication scheme using order information, delivery information, and payment information without an Active-X that is needed to pay for a purchased product by card in an existing electronic transaction.

### PRIORITY APPLICATION

This application claims the benefit under 35 U.S.C. 119 to Korean Application No. 10-2014-0057234, filed on 13 May 2014; which application is incorporated herein by reference in its entirety.

### BACKGROUND

1. Field of the Invention

The present invention relates to a card payment system and method in an electronic transaction, and more particularly, to a card payment system and method in an electronic transaction, which can effectively solve authentication and security problems that are caused by Active-X programs that are indiscriminately installed, by performing a card payment in a complex hybrid authentication scheme using order information, delivery information, and payment information without an Active-X program that is needed to pay for a purchased product by card in an existing electronic transaction.

2. Discussion of Related Art

Recently, along with the rapid development of the Internet, electronic transactions, in which products are purchased online, increase day by day. Electronic transactions are being increasingly applied to various products including daily necessities, housewares, and electronics.

Such development of electronic transactions has been a result of the development of communication networks as well as the provision of other benefits that cannot be obtained by sellers and purchasers through traditional transaction systems.

That is, advantageously, the sellers need not maintain a shop or a separate large warehouse for storing products, thereby saving funds on facilities and can reflect this in product prices while the purchasers may shop conveniently and at lower prices without needing to visit a shop.

That is, an electronic transaction is the sale or purchase of goods or services, a portion or all of which is electronically processed, for example, through an exchange of electronic documents.

Similarly to transactions made in the real world, all participants in the transaction participate in the electronic transaction. In the simplest electronic transaction, the participants in the electronic transaction include a cyber mall that provides goods or services, a consumer that purchases goods or services from the cyber mall, and a virtual bank or a credit card company that handles any monetary transactions for products.

In a process of the electronic transaction, first, a consumer accesses a cyber mall using a terminal connected to the Internet, such as a computer, and then shops. The consumer finds a desired product, delivers a purchase decision to the cyber mall, and provides a payment means such as a credit card number or a password.

The cyber mall verifies the credit card number and password that are presented by the customer with a virtual bank or credit card company, and requests payment of the purchase price. When the virtual bank or credit card company gives the payment to the cyber mall, the cyber mall delivers the product to the customer, thereby completing the purchase process.

Since a card payment that is currently used in online shopping malls (for example, Auction, G-market, and llst) internally requires Active-X programs, a user should download and install a card-number-entrance-related Active-X program and a keyboard-security-related Active-X program and also use a certificate when a certain amount (for example, 300,000 won) or more is paid.

Accordingly, the current card payment scheme is allowed in only MS Windows and disallowed in other operating systems (OSs). Active-X is Internet technology in which application programs are installed on a user's personal computer to allow documents or content that is on a web site to be used by the user, and an Active-X file is a program that is automatically installed when a user visits a specific webpage or that is installed when a user pushes a payment button while using an online shopping mall.

Recently, a need for card payment that can support all devices (for example, a desktop PC, a notebook PC, a tablet, and a smartphone), all OSs (for example, MS Windows, MAC OS, and Linux), and all browsers (for example, MS Explorer and Google Chrome) has increased.

In order to implement this, a no Popup and no Plug-in type card payment system is needed, which does not require installation of Active-X programs.

Recently, the Ministry of Science, ICT and Future Planning of the Republic of Korea has established a policy associated with the elimination of Active-X. Specifically, the Korean government will abolish the mandatory use of a certificate when a card payment is made in an Internet shopping mall, from June 2014. However, before another security and authentication means is provided to replace a certificate, the certificate may be maintained to be used.

The Financial Supervisory Service of the Republic of Korea opened an assessment board for authentication methods and has discussed LG CNS's MPay and PayGate's Amount Authentication (AA) as an alternative security authentication means. The LG CNS's MPay is similar to Mocapay, which is applied to the Auction, and is a scheme in which payment may be made with only a password since user card information is divided and stored in a server and a terminal The PayGate's AA is a scheme in which any amount is paid twice and authentication is made using the amount as an authentication number in order for user authentication.

However, it is inconvenient in that three-time payment and twice cancellation are needed for a payment, and also in a case that HTML5 is used, it is difficult to use the above-method because of browser compatibility or standards issues.

### SUMMARY OF THE INVENTION

The present invention is directed to a card payment system and method in an electronic transaction, which can effectively solve authentication and security problems that are caused by Active-X programs that are indiscriminately installed, by performing a card payment in a complex hybrid authentication scheme using order information, delivery information, and payment information without an Active-X that is needed to pay for a purchased product by card in an existing electronic transaction.

According to an aspect of the present invention, there is a card payment system in an electronic transaction, the system including at least one user terminal, a shopping mall server configured to provide an online shopping mall service such that a user joined as a member purchases a previously registered product through the user terminal, and a card company server configured to provide a card payment approval service for the purchased product of the user, the card payment approval service being requested by the shopping mall server, in which the shopping mall server requests a test payment from a card company server corresponding to a card company name based on user authentication information including the card company name, a card number, a delivery address, and an allowed payment region, stores the card company name, a portion of the card number, the delivery address, and the allowed payment region of the user based on approval completion information for the test payment request transmitted from the card company server, receives card payment information and delivery information for the purchased product from the user terminal, compares the received card payment information and delivery information with the stored delivery address and allowed payment region, and requests a card payment for the product from the card company server using the card payment information for the purchased product when the comparison result is the same.

The shopping mall server may automatically cancel the requested test payment upon receiving approval completion information for the test payment request from the card company server after requesting the test payment from the card company server such that a predetermined test payment amount is paid.

The shopping mall server may generate a unique authentication number for authenticating the user upon requesting the test payment and transmit the generated unique authentication number to the card company server in addition to test payment request information, the card company server may compare the test payment request information transmitted from the shopping mall server with pre-registered card company member information and transmit the unique authentication number for authenticating the user to the user terminal in addition to transmitting the approval completion information for the test payment request when the user is a pre-registered card company member, and the shopping mall server may compare a unique authentication number for authenticating the user that is entered from the user terminal with the generated unique authentication number for authenticating the user and store the card company name, a portion of the card number, the delivery address, and the allowed payment region of the user when the authentication numbers are the same.

The card company server may transmit the unique authentication number for authenticating the user in a short message format.

The shopping mall server may provide a service such that card payment information including a remaining portion of the card number other than the previously stored portion of the card number, a card expiration date, and a card password is entered through the user terminal when the purchased product is paid for by card.

The shopping mall server may generate a unique authentication number for delivering the purchased product, transmit the generated unique authentication number to the card company server in addition to the stored portion of the card number and the card payment information including the remaining portion of the card number, the card expiration date, and the card password, and set the purchased product to a delivery disabled state, the card company server may process the card payment information transmitted from the shopping mall server and transmit the unique authentication number for delivering the purchased product to the user terminal in addition to transmitting approval completion information for the card payment request for the product to the shopping mall server, and the shopping mall server may compare a unique authentication number for delivering the purchased product that is entered from the user terminal with the generated unique authentication number for delivering the purchased product and change the delivery disabled state to a delivery enabled state when the unique authentication numbers are the same.

The card company server may transmit the unique authentication number for delivering the purchased product in a short message format.

According to another aspect of the present invention, there is provided a card payment method in an electronic transaction using a system including at least one user terminal that accesses a shopping mall server through a communication network and a card company server, the method including (a) requesting, through the shopping mall server, a test payment from a card company server corresponding to a card company name based on user authentication information including the card company name, a card number, a delivery address, and an allowed payment region that are entered from the user terminal, (b) storing, through the shopping mall server, the card company name, a portion of the card number, the delivery address, and the allowed payment region of the user based on approval completion information for the test payment request transmitted from the card company server, and (c) receiving, through the shopping mall server, card payment information and delivery information for a purchased product from the user terminal, comparing the received card payment information and delivery information with the delivery address and allowed payment region stored in (b), and requesting a card payment for the product from the card company server using the card payment information for the purchased product when the received card payment information and delivery information match the stored delivery address and allowed payment region.

In (a), the shopping mall server may automatically cancel the requested test payment upon receiving approval completion information for the test payment request from the card company server after requesting the test payment from the card company server such that a predetermined test payment amount is paid.

In (a), the shopping mall server may generate a unique authentication number for authenticating the user upon requesting the test payment and transmit the generated unique authentication number to the card company server in addition to test payment request information, the card company server may compare the test payment request information transmitted from the shopping mall server with pre-registered card company member information and transmit the unique authentication number for authenticating the user to the user terminal in addition to transmitting the approval completion information for the test payment request when the user is a pre-registered card company member, and the shopping mall server may compare a unique authentication number for authenticating the user that is entered from the user terminal with the generated unique authentication number for authenticating the user and store the card company name, a portion of the card number, the delivery address, and the allowed payment region of the user when the authentication numbers are the same.

The card company server may transmit the unique authentication number for authenticating the user in a short message format.

The shopping mall server may provide a service such that card payment information including a remaining portion of the card number other than the previously stored portion of the card number, a card expiration date, and a card password is entered through the user terminal when the purchased product is paid for by card.

The shopping mall server may generate a unique authentication number for delivering the purchased product, transmit the generated unique authentication number to the card company server in addition to the stored portion of the card number and the card payment information including the remaining portion of the card number, the card expiration date, and the card password, and set the purchased product to a delivery disabled state, the card company server may process the card payment information transmitted from the shopping mall server and transmit the unique authentication number for delivering the purchased product to the user terminal in addition to transmitting approval completion information for the card payment request for the product to the shopping mall server, and the shopping mall server may compare a unique authentication number for delivering the purchased product that is entered from the user terminal with the generated unique authentication number for delivering the purchased product and change the delivery disabled state to a delivery enabled state when the unique authentication numbers are the same.

The card company server may transmit the unique authentication number for delivering the purchased product in a short message format.

According to still another aspect of the present invention, there is provided a computer-readable recording medium recording a computer program for executing the above-described card payment method.

The card payment method in an electronic transaction according to an embodiment of the present invention may be implemented as computer-readable codes on the computer-readable recording medium. The computer-readable recording medium is any kind of recording medium for storing data that may be read by a computer system.

Examples of the computer-readable recording medium include a read-only memory (ROM), a random-access memory (RAM), a CD-ROM, a magnetic tape, a hard disk, a floppy disk, a mobile storage device, a non-volatile memory (for example, flash memory), and an optical data storage device.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is an overall block diagram showing a card payment system in an electronic transaction according to an embodiment of the present invention;

FIG. 2 is a flowchart showing a card payment method in an electronic transaction according to an embodiment of the present invention; and

FIGS. 3 and 4 are conceptual views showing a card payment method in an electronic transaction according to an embodiment of the present invention.

### DETAILED DESCRIPTION OF EXEMPLARY EMBODIMENTS

Hereinafter, embodiments of the present invention will be described in detail with reference to the accompanying drawings. The present invention may, however, be embodied in different forms and should not be construed as limited to the embodiments set forth herein. Rather, these embodiments are provided so that this disclosure will be thorough and complete, and will fully convey the concept of the invention to those skilled in the art.

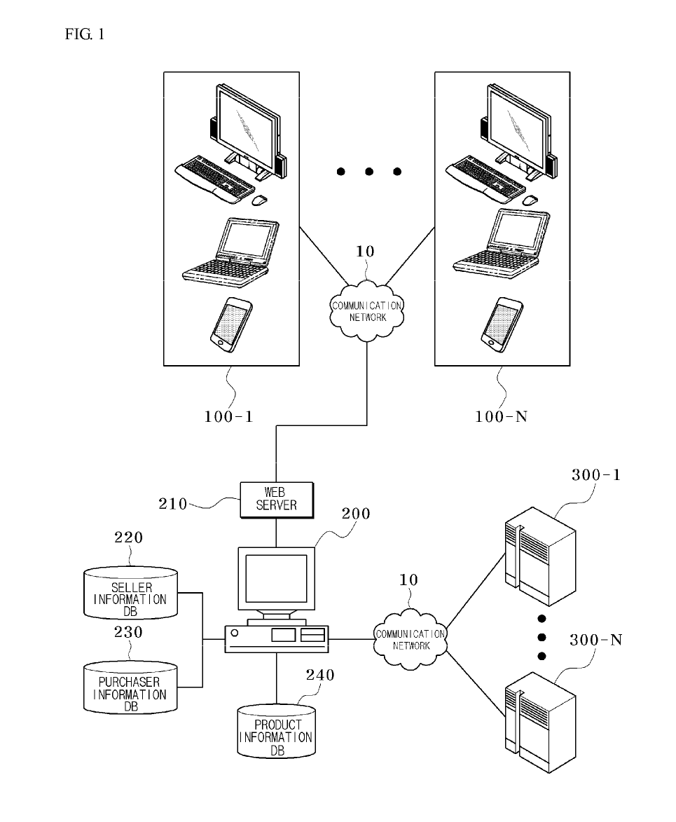

FIG. 1 is an overall block diagram showing illustrating a credit card payment system in an electronic transaction according to an embodiment of the present invention.

Referring to FIG. 1, a card payment system in an electronic transaction according to an embodiment of the present invention may include at least one user terminal 100-1 to 100-N, a shopping mall server 200, and at least one card company server 300-1 to 300-N.

Here, the user terminal 100-1 to 100-N is connected to a web server 210 of the shopping mall server 200 through a communication network 10 and includes a typical web browser that is used to retrieve and display a webpage, such as various hyper text markup language (HTML) documents, provided by the web server 210 of the shopping mall server 200 on a screen.

The communication network 10 refers to an open global computer network structure that provides several services in the TCP/IP protocol and its upper layer and provides an environment in which any user (for example, a purchaser or seller) of the user terminal 100-1 to 100-N may access the web server 210 of the shopping mall server 200. The communication network 10 may be a wired or wireless Internet, or a core network integrated with a wired public network, a wireless mobile communication network, or a portable Internet network.

In general, the user terminal 100-1 to 100-N may be a computer such as a desktop personal computer (PC) and a notebook PC, but is not limited thereto. The user terminal 100-1 to 100-N may be any kind of wired/wireless communication device that may access the web server 210 of the shopping mall server 200 through the communication network 10 to use various online shopping mall services.

Examples of the user terminal 100-1 to 100-N include various mobile terminals for performing communication through the wireless Internet or portable Internet, and may also refer to any wired/wireless home/communication device having a user interface for accessing the web server 210 of the shopping mall server 200, such as a palm personal computer (PC), a smartphone, a mobile game console, a tablet PC, an iPad and so on.

Here, it will be understood that when the user terminal 100-1 to 100-N is implemented as a smartphone, the smartphone is an open-operating-system-based phone in which a user can freely download, use, and delete a variety of desired application programs, unlike a general cell phone (namely, a feature phone), and may be a communication device including a mobile phone having a mobile office function in addition to functions such as voice/video calls, Internet data communication, etc. or any Internet phone or tablet PC which can access the Internet but does not have a voice call function.

In particular, when the user terminal 100-1 to 100-N according to an embodiment of the present invention is implemented as a smartphone, the smartphone may download a shopping-mall-related application (for example, an Auction app and a Gmarket app) through an app store and perform a shopping-mall-related application service.

As such, a user may access the web server 210 of the shopping mall server 200 through a shopping-mall-related application service installed in the smartphone to use a transaction brokerage service for various products or services.

The shopping mall server 200, which is a server for operating an online shopping mall service through the communication network 10 to broker a general transaction, an auction, a reverse auction, and bargaining of a product or service between a seller and a purchaser, generally manages a webpage or online shopping mall service needed to operate the shopping mall such that registration of various products that the seller intends to sell may be accepted from the user terminal 100-1 to 100-N through the communication network 10 and the various registered products may be provided to the user terminal 100-1 to 100-N through the web server 210 connected to the communication network 10, allowing the purchaser to purchase a necessary product.

In addition, the shopping mall server 200 may manage the webpage or online shopping mall service such that payment for the product that is selected by the purchaser from among a list of the sale products may be processed, a process required for delivery, such as notification of guidance about the paid product to the seller, may be performed to deliver the paid product to the purchaser, and delivery of the product in transit may be tracked.

Furthermore, the web server 210 of the shopping mall server 200 functions to connect the shopping mall server 200 with the user terminal 100-1 to 100-N through the communication network 10 and to provide an online shopping mall service of the shopping mall server 200 through a certain webpage or shopping-mall-dedicated app. The web server 210 may perform the same function as that of the shopping mall server 200.

In addition, the web server 210 of the shopping mall server 200 is connected with the user terminal 100-1 to 100-N through the communication network 10 and configured to transmit a shopping mall webpage in response to an access of the user terminal 100-1 to 100-N, transmit a member authentication means (for example, a module for receiving a member ID and a password) to the shopping mall webpage of the user terminal 100-1 to 100-N in response to an online shopping mall service request, and provide an online shopping mall service to the user terminal 100-1 to 100-N in response to reception of the member authentication data from the user terminal 100-1 to 100-N.

A seller information DB 220 included in the shopping mall server 200 is a DB for recording and managing seller information (for example, a seller ID, a password, contact information, etc.), product information (for example, a name, a price, a brand, a feature, etc. of a product), or service information, which is registered by a joined seller and may be read or updated with new seller information by the shopping mall server 200.

A purchaser information DB 230 included in the shopping mall server 200 is a DB for recording and managing purchaser information, for example, a purchaser ID, a password, contact information, cart information, product information about a product being bid on, product information about a product for which bidding has concluded, product information about a bargained product, product information about a paid product, delivery information, purchase decision information, product information of a favorite shop, and so on, which is registered by a joined purchaser and may be read or updated with new purchaser information by the shopping mall server 200.

A product information DB 240 included in the shopping mall server 200 is a DB for recording information about various sale products or services, which may be read or updated with new sale product or service information by the shopping mall server 200.

In particular, the shopping mall server 200 receives authentication information including a card company name, a card number, a delivery address, and an allowed payment region of a user that are entered through the user terminal 100-1 to 100-N and requests a test payment from a card company server 300-1 to 300-N corresponding to the card company name of the user to make a test payment.

In this case, after requesting the test payment from the card company server 300-1 to 300-N such that that a predetermined test payment amount (for example, 1000 won) may be paid, the shopping mall server 200 may cancel the requested test payment upon receiving approval completion information for the test payment request from the card company server 300-1 to 300-N.

In addition, the shopping mall server 200 may generate and transmit a unique authentication number for authenticating a corresponding user to the card company server 300-1 to 300-N in addition to information on the test payment request when the test payment is requested.

Furthermore, the shopping mall server 200 receives the approval completion information for the test payment request from the card company server 300-1 to 300-N and stores a card company name, a portion of the card number (for example, the first six digits of the credit card (indicating the kind of card, as a BIN number)+the last four digits of the credit card), a delivery address, an allowed payment region (for example, setting a country or region (Seoul, South Korea)), and an allowed daily e-coupon payment amount of the user in the seller information DB 220, the purchaser information DB 230, or a separate database (DB) based on the received approval completion information.

A portion of the card number may include, but not limited to, the first six digits (for identifying the card company and the kind of card) and the last four digits. The range of the portion of the card number may vary depending on embodiments.

In this case, the shopping mall server 200 may compare a unique authentication number for authenticating the user that is entered through the user terminal 100-1 to 100-N with a previously generated unique authentication number for authenticating the user and store a card company name, a portion of a card number, a delivery address, an allowed payment region, and an allowed daily e-coupon payment amount when the numbers are the same.

In addition, the shopping mall server 200 receives card payment information and delivery information for a purchased product from the user terminal 100-1 to 100-N, compares the received card payment information and delivery information with the previously stored delivery address and allowed payment region, and requests a card payment for the product from the card company server 300-1 to 300-N using the card payment information for the purchased product when the received card payment information and delivery information match the previously stored delivery address and allowed payment region.

In addition, the shopping mall server 200 may provide a service such that card payment information including the remaining portion other than the previously stored portion of the card number, a card expiration date, and a card password is entered through the user terminal 100-1 to 100-N when the purchased product is paid for by card.

In addition, the shopping mall server 200 generates and transmits a unique authentication number for delivering the purchased product to the card company server 300-1 to 300-N in addition to the card payment information including the remaining portion of the card number, the card expiration date, and the card password that are entered through the user terminal 100-1 to 100-N, and also sets the purchased product to a delivery disabled state.

Furthermore, the shopping mall server 200 may receive a unique authentication number for delivering the purchased product that is entered through the user terminal 100-1 to 100-N and may compare the unique authentication number with the previously generated unique authentication number for delivering the purchased product and change the set delivery disabled state to a delivery enabled state when the unique authentication numbers are the same.

Moreover, the card company server 300-1 to 300-N is linked with the shopping mall server 200 through the communication network 10 and provides a card payment approval service for the purchased product of the user, which is requested by the shopping mall server 200. Specifically, the card company server 300-1 to 300-N compares test payment request information transmitted from the shopping mall server 200 with previously registered card company member information and transmits approval completion information for the test payment request to the shopping mall server 200 when the user is a previously registered card company member.

In addition, when the card company server 300-1 to 300-N receives the unique authentication number for authenticating the user from the shopping mall server 200, the card company server 300-1 to 300-N may transmit the unique authentication number for authenticating the user to the user terminal 100-1 to 100-N in addition to transmitting the approval completion information for the test payment request to the shopping mall server 200. In this case, the card company server 300-1 to 300-N may transmit the unique authentication number for authenticating the user in the form of a short messaging service (SMS).

Furthermore, the card company server 300-1 to 300-N functions to process card payment information transmitted from the shopping mall server 200 and transmit approval completion information for the card payment request for the product to the shopping mall server 200.

In addition, when the card company server 300-1 to 300-N receives the unique authentication number for delivering the purchased product from the shopping mall server 200, the card company server 300-1 to 300-N may transmit the unique authentication number for delivering the purchased product to the user terminal 100-1 to 100-N in addition to transmitting the approval completion information for the card payment request for the product to the shopping mall server 200. In this case, the card company server 300-1 to 300-N may transmit the unique authentication number for delivering the purchased product in the form of a short messaging service (SMS).

The shopping mall server 200 according to an embodiment of the present invention generates and transmits the unique authentication number for authenticating the user and the unique authentication number for purchased product delivery to the card company server 300-1 to 300-N, respectively, but the present invention is not limited thereto. The card company server 300-1 to 300-N may generate and transmit a unique authentication number to a corresponding user terminal 100-1 to 100-N, and then the shopping mall server 200 may perform an authentication process on the unique authentication number in linkage with the card company server 300-1 to 300-N.

Moreover, according to an embodiment of the present invention, the unique authentication number for authenticating the user is different from the unique authentication number for delivering the purchased product, but the present invention is not limited thereto. One unique authentication number may be generated and used for both of the authentication and the delivery.

A card payment method in an electronic transaction according to an embodiment of the present invention will be described in detail below.

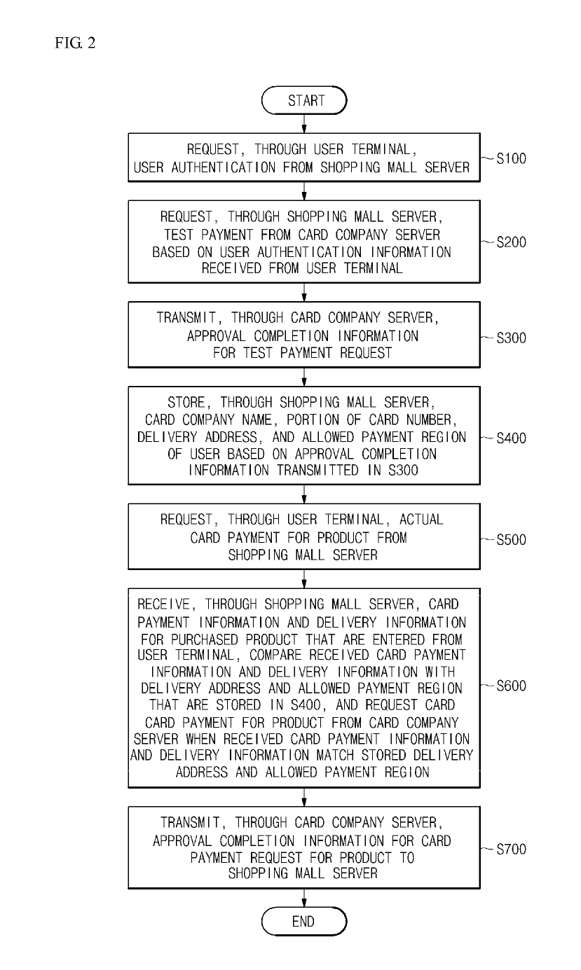

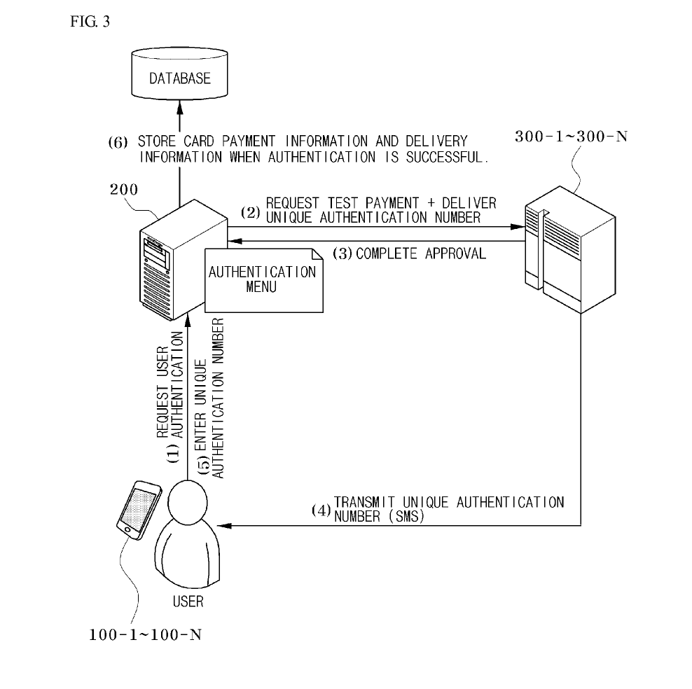

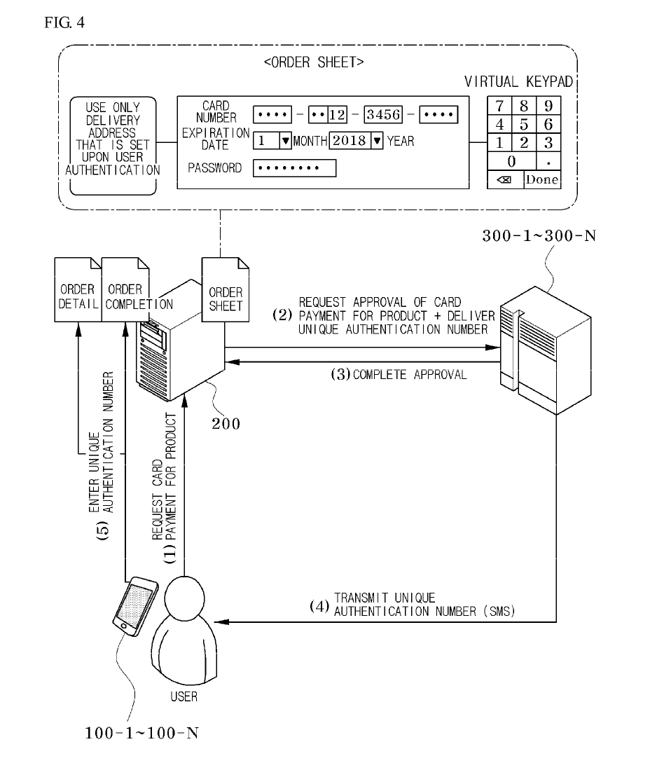

FIG. 2 is a flowchart showing a card payment method in an electronic transaction according to an embodiment of the present invention, and FIGS. 3 and 4 are conceptual views showing a card payment method in an electronic transaction according to an embodiment of the present invention.

Referring to FIGS. 2 and 4, first, a user joins the shopping mall server 200 as a member through the user terminal 100-1 to 100-N and then performs a card pre-authentication procedure primarily.

That is, the card pre-authentication procedure includes requesting, through the user terminal 100-1 to 100-N, user authentication from the shopping mall server 200 by entering authentication information into an authentication menu for the card pre-authentication that is provided by the web server 210 of the shopping mall server 200 (S100).

In this case, the authentication information may include, for example, a card company name (or a card company type), a card number, a delivery address, and an allowed payment region (for example, setting a country or region (Seoul, South Korea))

Subsequently, the procedure includes receiving, through the shopping mall server 200, the authentication information including the card company name, the card number, the delivery address, and the allowed payment region that are entered from the user terminal 100-1 to 100-N and requesting a test payment from the card company server 300-1 to 300-N corresponding to the card company name of the user based on the received user authentication information (S200).

In this case, after requesting the test payment from the card company server 300-1 to 300-N such that that a predetermined test payment amount (for example, 1000 won) may be paid, the shopping mall server 200 may cancel the requested test payment upon receiving approval completion information for the test payment request from the card company server 300-1 to 300-N.

In addition, the shopping mall server 200 may generate and transmit a unique authentication number for authenticating a corresponding user to the card company server 300-1 to 300-N in addition to information on the test payment request when the test payment is requested.

Next, the procedure includes comparing, through the card company server 300-1 to 300-N, comparing the test payment request information transmitted from the shopping mall server 200 with pre-registered card company member information and transmitting approval completion information for the test payment request to the shopping mall server 200 when the user is a pre-registered card company member (S300).

In this case, when the card company server 300-1 to 300-N receives the unique authentication number for authenticating the user from the shopping mall server 200, the card company server 300-1 to 300-N may transmit the unique authentication number for authenticating the user to the user terminal 100-1 to 100-N in addition to transmitting the approval completion information for the test payment request to the shopping mall server 200. The card company server 300-1 to 300-N may transmit the unique authentication number for authenticating the user in the form of a short messaging service (SMS).

Subsequently, the procedure includes, through the shopping mall server 200, receiving the approval completion information for the test payment request from the card company server 300-1 to 300-N and storing a card company name, a portion of a card number (for example, the first six digits of the credit card (indicating the kind of card as a BIN number) +the last four digits of the credit card), a delivery address, and an allowed payment region based on the received approval completion information (S400).

In this case, the shopping mall server 200 may compare the unique authentication number for authenticating the user that is entered through the user terminal 100-1 to 100-N with a previously generated unique authentication number for authenticating the user and store the card company name, a portion of the card number, the delivery address, and the allowed payment region when the numbers are the same.

After completing the card pre-authentication procedure primarily by performing S100 to S400 as described above, secondarily, a product is purchased by the user and an actual card payment procedure is performed without an existing authentication window.

That is, the procedure includes requesting, through the user terminal 100-1 to 100-N, an actual card payment for the purchased product from the shopping mall server 200 by entering card payment information and delivery information for the purchased product into an order sheet that is provided by the web server 210 of the shopping mall server 200 (S500).

In this case, the shopping mall server 200 may provide a service such that card payment information including the remaining portion other than the previously stored portion of the card number, a card expiration date, and a card password is entered through the user terminal 100-1 to 100-N when the purchased product is paid for by card (see FIG. 4). When the card payment information is entered, keyboard security may be replaced by a virtual keypad.

Subsequently, the procedure includes receiving, through the shopping mall server 200, card payment information and delivery information for a purchased product that are entered from the user terminal 100-1 to 100-N, comparing the received card payment information and delivery information with the delivery address and allowed payment region that are stored in S400, and requesting a card payment for the product from the card company server 300-1 to 300-N using the card payment information for the purchased product when the received card payment information and delivery information match the stored delivery address and allowed payment region (S600).

In this case, the shopping mall server 200 may generate and transmit a unique authentication number for delivering the purchased product to the card company server 300-1 to 300-N in addition to the portion of the card number that is previously stored and the card payment information including the remaining portion of the card number, the card expiration date, and the card password that are entered through the user terminal, and also set the purchased product to a delivery disabled state.

Next, the procedure includes processing, through the card company server 300-1 to 300-N, the card payment information transmitted from the shopping mall server 200 and transmitting approval completion information for the card payment request for the product to the shopping mall server 200 (S700).

In this case, when the card company server 300-1 to 300-N receives the unique authentication number for delivering the purchased product from the shopping mall server 200, the card company server 300-1 to 300-N may transmit the unique authentication number for delivering the purchased product to the user terminal 100-1 to 100-N in addition to transmitting the approval completion information for the card payment request for the product to the shopping mall server 200. In addition, the card company server 300-1 to 300-N may transmit the unique authentication number for delivering the purchased product in the form of a short messaging service (SMS).

Next, the user checks the unique authentication number for delivering the purchased product and enters the checked unique authentication number for delivering the purchased product into an order detail and/or an order completion menu provided by the web server 210 of the shopping mall server 200 through the user terminal 100-1 to 100-N to transmit the unique authentication number to the shopping mall server 200.

Subsequently, the shopping mall server 200 may compare the unique authentication number for delivering the purchased product that is entered from the user terminal 100-1 to 100-N with the previously generated unique authentication number for delivering the purchased product and change the set delivery disabled state to a delivery enabled state to perform delivery processing when the unique authentication numbers are the same.

On the other hand, when the shopping mall server 200 compares the unique authentication number for delivering the purchased product that is entered from the user terminal 100-1 to 100-N with the previously generated unique authentication number for delivering the purchased product and the unique authentication numbers are different a predetermined number of times or more, the shopping mall server 200 may set a card payment disallowance LOCK.

After performing an actual card payment process secondarily as described above, the card payment for the product may be deactivated when the following conditions are not satisfied.

First, a delivery destination that is entered after actual card payment allows only a delivery destination that is used upon a primary card pre-authentication. Thus, when the delivery destination is not authenticated, the payment is deactivated. Thus, since delivery is limited to only an authenticated delivery destination, an illegal use may be prevented. If the delivery destination is desired to be changed, re-authentication should be performed.

For a product that does not require delivery, such as an e-coupon, an illegal use may be prevented by setting a daily payment limit amount and checking an accumulated payment amount and an accumulated payment number.

Second, a user's position is determined using a user IP upon an actual card payment, and when the position is not in the allowed card payment region that is set upon primary card pre-authentication (for example, payment in a foreign country), the hybrid authentication payment according to an embodiment of the present invention is deactivated .

Third, when a daily accumulated payment amount exceeds a certain limit, the hybrid authentication payment according to an embodiment of the present invention is deactivated.

Fourth, when the hybrid authentication according to an embodiment of the present invention is not performed within a certain time (for example, one hour) after production order, an order cancellation and refund are automatically performed.

The hybrid authentication card payment method according to am embodiment of the present invention is a payment scheme that performs authentication by applying information that is set through the primary authentication and a post-order approval scheme together with a delivery limit function. The hybrid authentication card payment method is an authentication scheme includes using an unauthenticated card payment upon actual card payment of a product, setting the product to a delivery disabled state after the payment, and enabling a deliver stage or a post-payment process only when the unique authentication number for delivering the purchased product is authenticated, that is, a scheme in which the authentication is performed after, not upon, the actual card payment.

The card payment method in the electronic transaction according to an embodiment of the present invention can also be implemented as computer-readable codes on a computer-readable recording medium. The computer-readable recording medium is any kind of recording medium for storing data that may be read by a computer system.

Examples of the computer-readable recording medium include a read-only memory (ROM), a random-access memory (RAM), a CD-ROM, a magnetic tape, a hard disk, a floppy disk, a mobile storage device, a non-volatile memory (flash memory), and an optical data storage device.

The computer-readable recording medium can also be distributed over computer systems connected through a computer communication network so that the computer readable codes are stored and executed in a distributed fashion.

With the card payment system and method in the electronic transaction according to an embodiment of the present invention, it is possible to effectively solve authentication and security problems that are caused by Active-X programs that are indiscriminately installed, by performing a card payment in a complex hybrid authentication scheme using order information, delivery information, and payment information without an Active-X that is needed to pay for the purchased product by card in an existing electronic transaction.

While the preferred embodiments of the card payment system and method in the electronic transaction have been described, the present invention is not limited thereto. Various modifications may be made therein, and the appended claims are intended to cover all such modifications which may fall within the spirit and scope of the invention.

What is claimed is:

1. A card payment system in an electronic transaction, the system comprising:
at least one user terminal;
a shopping mall server configured to provide an online shopping mall service such that a user joined as a member purchases a previously registered product through the user terminal; and
a card company server configured to provide a card payment approval service for the purchased product of the user, the card payment approval service being requested by the shopping mall server,
wherein the shopping mall server requests a test payment from a card company server corresponding to a card company name based on user authentication information including the card company name, a card number, a delivery address, and an allowed payment region that are entered from the user terminal, stores the card company name, a portion of the card number, the delivery address, and the allowed payment region of the user based on approval completion information for the test payment request transmitted from the card company server, receives card payment information and delivery information for the purchased product from the user terminal, compares the received card payment information and delivery information with the stored delivery address and allowed payment region, and requests a card payment for the product from the card company server using the card payment information for the purchased product when the received card payment information and delivery information match the stored delivery address and allowed payment region.

2. The system of claim 1, wherein the shopping mall server automatically cancels the requested test payment upon receiving approval completion information for the test payment request from the card company server after requesting the test payment from the card company server such that a predetermined test payment amount is paid.

3. The system of claim 1, wherein
the shopping mall server generates a unique authentication number for authenticating the user upon requesting the test payment and transmits the generated unique authentication number to the card company server in addition to test payment request information,
the card company server compares the test payment request information transmitted from the shopping mall server with pre-registered card company member information and transmits the unique authentication number for authenticating the user to the user terminal in addition to transmitting the approval completion information for the test payment request to the shopping mall server when the user is a pre-registered card company member, and
the shopping mall server compares a unique authentication number for authenticating the user that is entered from the user terminal with the generated unique authentication number for authenticating the user and stores the card company name, a portion of the card number, the delivery address, and the allowed payment region of the user when the authentication numbers are the same.

4. The system of claim 3, wherein the card company server transmits the unique authentication number for authenticating the user in a short message format.

5. The system of claim 1, wherein the shopping mall server provides a service such that card payment information including a remaining portion of the card number other than the previously stored portion of the card number, a card expiration date, and a card password is entered through the user terminal when the purchased product is paid for by card.

6. The system of claim 5, wherein,
the shopping mall server, when the user requests a card payment for the product, generates a unique authentication number for delivering the purchased product, transmits the generated unique authentication number to the card company server in addition to the stored portion of the card number and the card payment information including the remaining portion of the card number, the card expiration date, and the card password, and sets the purchased product to a delivery disabled state,
the card company server processes the card payment information transmitted from the shopping mall server and transmits the unique authentication number for delivering the purchased product to the user terminal in addition to transmitting approval completion information for the card payment request for the product to the shopping mall server, and
the shopping mall server compares a unique authentication number for delivering the purchased product that is entered from the user terminal with the generated unique authentication number for delivering the purchased product and changes the delivery disabled state to a delivery enabled state when the unique authentication numbers are the same.

7. The system of claim 6, wherein the card company server transmits the unique authentication number for delivering the purchased product in a short message format.

8. A card payment method in an electronic transaction using a system including at least one user terminal that accesses a shopping mall server through a communication network and a card company server, the method comprising:
(a) requesting, through the shopping mall server, a test payment from a card company server corresponding to a card company name based on user authentication information including the card company name, a card number, a delivery address, and an allowed payment region that are entered from the user terminal;
(b) storing, through the shopping mall server, the card company name, a portion of the card number, the delivery address, and the allowed payment region of the user based on approval completion information for the test payment request transmitted from the card company server; and
(c) receiving, through the shopping mall server, card payment information and delivery information for a purchased product from the user terminal, comparing the received card payment information and delivery information with the delivery address and allowed payment region stored in (b), and requesting a card payment for the product from the card company server using the card payment information for the purchased product when the received card payment information and delivery information match the stored delivery address and allowed payment region.

9. The method of claim 8, wherein, in (a), the shopping mall server automatically cancels the requested test payment upon receiving approval completion information for the test payment request from the card company server after requesting the test payment from the card company server such that a predetermined test payment amount is paid.

10. The method of claim 8,
wherein, in (a), the shopping mall server generates a unique authentication number for authenticating the user upon requesting the test payment and transmits the generated unique authentication number to the card company server in addition to test payment request information,
the card company server compares the test payment request information transmitted from the shopping mall server with pre-registered card company member information and transmits the unique authentication number for authenticating the user to the user terminal in addition to transmitting the approval completion information for the test payment request to the shopping mall server when the user is a pre-registered card company member, and
wherein, in (b), the shopping mall server compares a unique authentication number for authenticating the user that is entered from the user terminal with the generated unique authentication number for authenticating the user and stores the card company name, a portion of the card number, the delivery address, and the allowed payment region of the user when the authentication numbers are the same.

11. The method of claim 10, wherein the card company server transmits the unique authentication number for authenticating the user in a short message format.

12. The method of claim 8, wherein, in (c), the shopping mall server provides a service such that card payment information including a remaining portion of the card number other than the previously stored portion of the card number, a card expiration date, and a card password is entered through the user terminal when the purchased product is paid for by card.

13. The method of claim 12, wherein
the shopping mall server, when the user requests a card payment for the product, generates a unique authentication number for delivering the purchased product, transmits the generated unique authentication number to the card company server in addition to the stored portion of the card number and the card payment information including the remaining portion of the card number, the card expiration date, and the card password, and sets the purchased product to a delivery disabled state,
the card company server processes the card payment information transmitted from the shopping mall server and transmits the unique authentication number for delivering the purchased product to the user terminal in addition to transmitting approval completion information for the card payment request for the product to the shopping mall server, and
the shopping mall server compares a unique authentication number for delivering the purchased product that is entered from the user terminal with the generated unique authentication number for delivering the purchased product and changes the delivery disabled state to a delivery enabled state when the unique authentication numbers are the same.

14. The method of claim 13, wherein the card company server transmits the unique authentication number for delivering the purchased product in a short message format.

15. A computer-readable recording medium recording a computer program for causing a computer to execute a method comprising:
(a) requesting, through the shopping mall server, a test payment from a card company server corresponding to a card company name based on user authentication information including the card company name, a card number, a delivery address, and an allowed payment region that are entered from the user terminal;
(b) storing, through the shopping mall server, the card company name, a portion of the card number, the delivery address, and the allowed payment region of the user based on approval completion information for the test payment request transmitted from the card company server; and
(c) receiving, through the shopping mall server, card payment information and delivery information for a purchased product from the user terminal, comparing the received card payment information and delivery information with the delivery address and allowed payment region stored in (b), and requesting a card payment for the product from the card company server using the card payment information for the purchased product when the received card payment information and delivery information match the stored delivery address and allowed payment region.
